(19) United States
(12) Patent Application Publication
(10) Pub. No.: US 2025/0100768 A1
(43) Pub. Date: Mar. 27, 2025

(54) ARTICLE ORGANIZER AND STABILIZER

(71) Applicant: Keith Owens, JR., Pitman, NJ (US)

(72) Inventor: Keith Owens, JR., Pitman, NJ (US)

(73) Assignee: Keith Owens, JR., Pitman, NJ (US)

(21) Appl. No.: 18/739,560

(22) Filed: Jun. 11, 2024

Related U.S. Application Data
(60) Provisional application No. 63/585,014, filed on Sep. 25, 2023.

(51) Int. Cl. B65D 63/14; B25H 3/00; B65D 63/18

(52) U.S. Cl. CPC B65D 63/14; B25H 3/00; B65D 63/18

(57) ABSTRACT

An apparatus for organizing and stabilizing objects may comprise a base and a number of fasteners. The fasteners may be configured to attachably and detachably clasp objects. Fasteners may be positioned at a proximate end of the base at a distal end of the base. The apparatus may be configured to clasp a plurality of coils of an object, wherein each coil length of the plurality of coils is selectable. The apparatus may provide selectable utilization of an object.

### CROSS REFERENCE TO RELATED APPLICATIONS

This application claims the benefit of U.S. Provisional Patent Application No. 63/585,014, filed Sep. 25, 2023, which is hereby incorporated herein by reference in its entirety.

### FIELD OF THE INVENTION

The present invention generally relates to methods and apparatuses for organizing and stabilizing objects. More specifically, the present invention generally relates to methods and apparatuses for organizing and stabilizing flexible objects such as, for example, cables, cords, lines, ropes, hoses, wires, and the like, non-flexible articles such as, for example, tools, containers, toys, and the like, or any appropriate combination thereof.

### BACKGROUND

It can be difficult to stow away objects, such as, for example, cords, ropes, hoses, string, etc. For example, after using a length of a flexible object, it may be difficult and frustrating to try to wrap the object in some organized fashion. Often, the object is stowed away as a tangled mess. It may be even more difficult and frustrating to try to unravel the tangled mess when using the object a next time. This may occur when trying to unravel, for example, extension cords, garden hoses, electrical cords connected to appliances, ropes, string, etc. To further exacerbate this difficulty and frustration, although only a small portion of an object may need to be untangled for use, often, the entire object must be untangled.

### SUMMARY

An apparatus for organizing and stabilizing objects may comprise a base and a number of fasteners. The base may be configured as a strap. The base may comprise a first side and a second side. The first side may be opposite the second side. The fasteners may be configured to secure objects. The fasteners may be configured as clasps. The fasteners may be configured to attachably and detachably clasp objects. Each side of the base may comprise a respective proximate end and distal end. A first number of fasteners may be positioned at a proximate end of a first side of the base and a second number of fasteners may be positioned at a distal end of the first side of the base. Optionally, a third number of fasteners may be positioned at a proximate end of a second side of the base and a fourth number of fasteners may be positioned at a distal end of the second side of the base.

The first number of fastener may be linearly arranged on the first side of the base with the second number of fasteners. The third number of fastener may be linearly arranged on the second side of the base with the fourth number of fasteners.

The base may be configured as a flexible base portion, such as a strap for example. The base may be configured as a non-flexible base portion. The base may be configured to comprise a combination of at least one flexible portion and at least one non-flexible portion.

The apparatus may be configured to clasp an object by fastening portions of the object to any fastener or fasteners of the apparatus. To facilitate fastening an object, each fastener of the first number of fasteners may be associated with a corresponding fastener of the second number of fasteners. To facilitate fastening an object, each fastener of the third number of fasteners may be associated with a corresponding fastener of the fourth number of fasteners. The apparatus may be configured to clasp an object by fastening, for example, a coil of the object to corresponding fasteners of the first and second number of fasteners. The apparatus may be configured to clasp an object by fastening, for example, a coil of the object to corresponding fasteners of the third and fourth number of fasteners.

The apparatus may be configured to clasp a plurality of coils of an object, wherein each coil length of the plurality of coils may be selectable. The apparatus may be configured to clasp a plurality of coils of an object, wherein each coil of the plurality of coils is of approximately equal length.

The apparatus may be configured to secure and organize a flexible object or a plurality of flexible objects. The apparatus may be configured to secure and organize a non-flexible object or a plurality of non-flexible objects. The apparatus may be configured to secure and organize a combination of flexible objects and non-flexible objects. The apparatus may be configured to secure and organize any appropriate object, such as, for example, a hose, a cable, a cord, a line, a rope, a wire, a tool, a container, a toy, or the like, or a combination thereof.

The apparatus may provide selectable utilization of an object. The apparatus may be configured to facilitate selecting a portion of an object to detach, while the remainder of the object remains stowed away. Upon utilization of the selected portion of the object, only the selected portion of the object needs to be reattached.

The apparatus may be configured to be attached to an appliance. For example, the apparatus may be configured to be attached to an appliance for stability, such as, for example, a ladder, a vehicle, a wall, or the like. The apparatus may be configured to be attached to an appliance for which the object is being used, such as for example, an appliance that uses electricity, wherein the object is an electrical cord. For example, the apparatus may be configured to be attached to a household appliance, such as, for example but not limited to a refrigerator, a toaster, a toaster oven, a microwave oven, or the like, or any other appropriate kitchen appliance. Household appliances may include, but are not limited to, a television, a radio, a streaming device, a portable heater, an electric blanket, a computer, a monitor, or the like, any other appropriate household appliance.

### BRIEF DESCRIPTION OF THE DRAWINGS

The instant disclosure will be more fully understood with reference to the following detailed description when taken in conjunction with the accompanying figures.

FIG. 1 depicts an example configuration of the apparatus securing and organizing an object, such as an electrical cord, illustrating a first portion and a second portion of the apparatus.

FIG. 2 depicts a more detailed illustration of a portion of the apparatus securing and organizing the electrical cord depicted in FIG. 1.

FIG. 3 depicts an example configuration of the apparatus securing and organizing an electrical cord in a workplace environment.

FIG. 4 is an example illustration of a side and front view of the apparatus securing and organizing an object, and an example illustration of a fastener of the apparatus.

FIG. 5 is another example illustration of a side and front view of the apparatus securing and organizing an object, and an example illustration of a fastener of the apparatus.

FIG. 6 is an example illustration of a detailed portion of the apparatus depicted in FIG. 5.

FIG. 7 is an example illustration of another detailed portion of the apparatus depicted in FIG. 5.

FIG. 8 is an example illustration of multiple detailed portions of the apparatus.

FIG. 9 is an example illustration of a detailed portion of the apparatus depicted in FIG. 8.

FIG. 10 is an example illustration of another detailed portion of the apparatus depicted in FIG. 8.

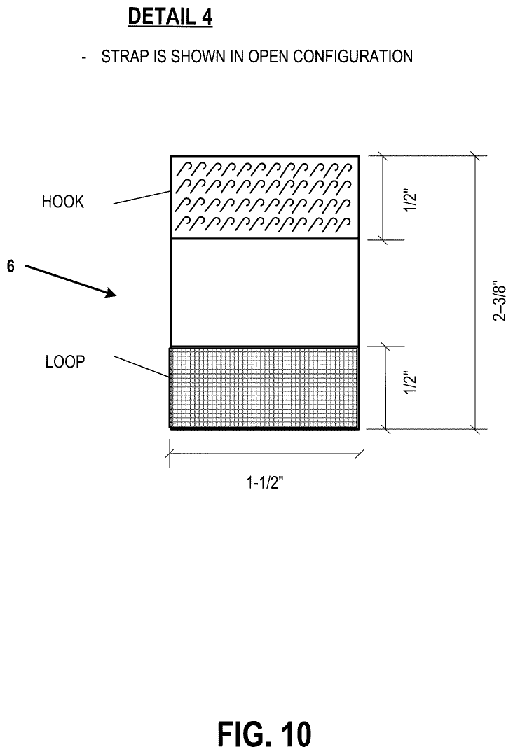

FIG. 11 is an example illustration of another detailed portion of the apparatus depicted in FIG. 8.

FIG. 12 is an illustration of an another example configuration of the apparatus.

FIG. 13A and FIG. 13B are illustrations of an example tripod configuration of the apparatus.

FIG. 14A and FIG. 14B are additional illustrations of an example tripod configuration of the apparatus.

FIG. 15 is an example illustration of a cross section of the apparatus comprising a support member.

FIG. 16 includes FIG. 16A, FIG. 16B, FIG. 16C, FIG. 16D, and FIG. 16E, which illustrate cross-sectional views of various example configurations of the apparatus.

FIG. 17 illustrates a front view of an example appliance configuration of the apparatus and an appliance.

FIG. 18 illustrates a side view of an example appliance configuration of the apparatus.

FIG. 19 provides a more detailed depiction of the example clasps 6 depicted in FIG. 18.

### DETAILED DESCRIPTION

For purposes of the present detailed description, unless otherwise stated, the singular shall include the plural and the plural shall include the singular. Further, when a list is provided, regardless of the conjunction used, the list shall be interpreted to include any combination thereof.

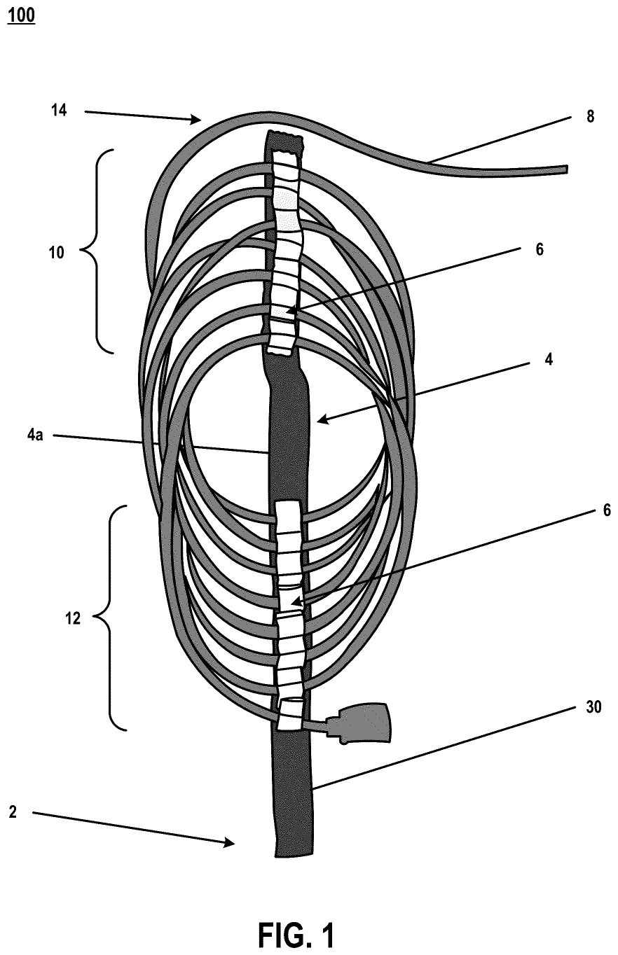

FIG. 1 depicts an example configuration of apparatus 100 securing and organizing object 8. Object 8 is depicted as an electrical cord as an example. An object, however, should not be limited to an electrical cord as depicted in FIG. 1. An object may comprise any appropriate object, such as but not limited to, for example, a hose, a cable (e.g., electrical, optical, etc.), a cord, a line, a rope, a wire, a tool, a container, a toy, or the like, or any appropriated combination thereof. Apparatus 100 may comprise base 4 and at least one fastener 6. Apparatus 100 may comprise any appropriate number of fasteners 6. Fasteners are labeled with a single identifier 6 for simplicity. Apparatus 100 may comprise proximate end 2 and distal end 14. Apparatus 100 may comprise a first number of fasteners 10. First number of fasteners 10 may comprise any appropriate number of fasteners 6, such as, for example, a single fastener 6 or a plurality of fasteners 6. Apparatus 100 may comprise a second number of fasteners 12. Second number of fasteners 12 may comprise any appropriate number of fasteners 6, such as, for example, a single fastener 6 or a plurality of fasteners 6. First number of fasteners 10 and second number of fasteners 12 may be arranged on base 4 in any appropriate manner. For example, as depicted in FIG. 1, first number of fasteners 10 and second number of fasteners 12 may be arranged on base 4 linearly (or approximately linearly) with a space therebetween.

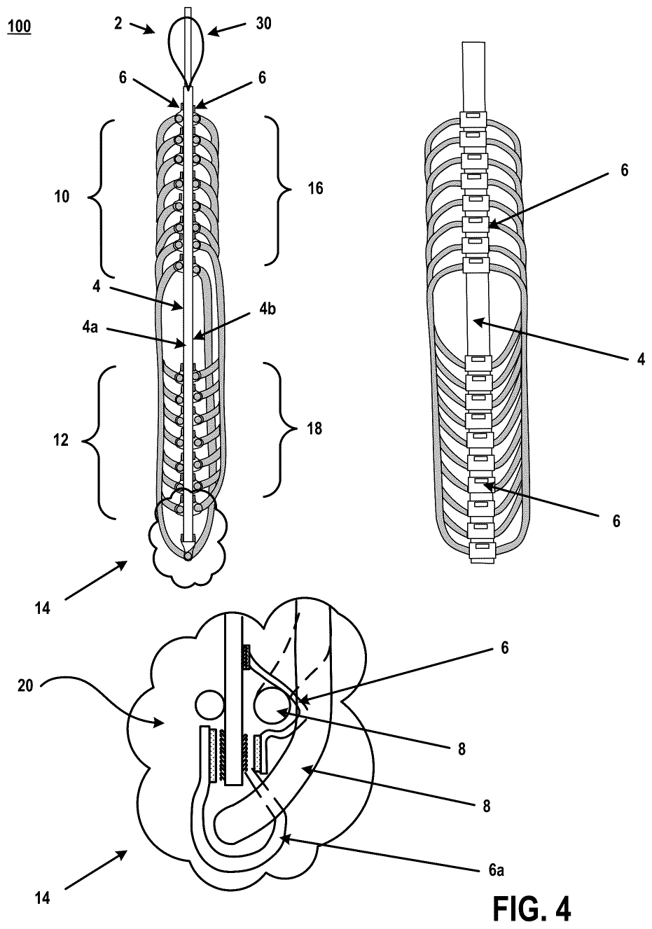

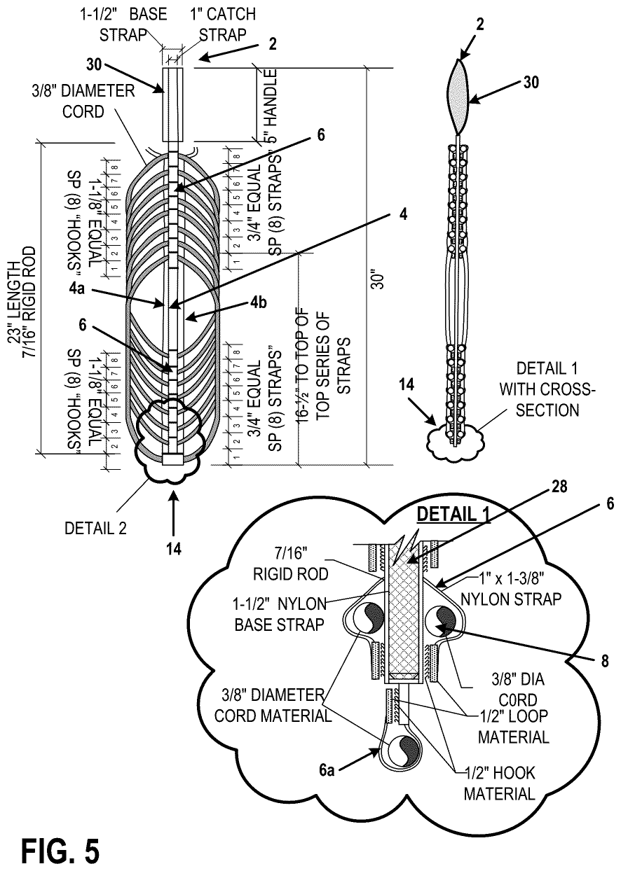

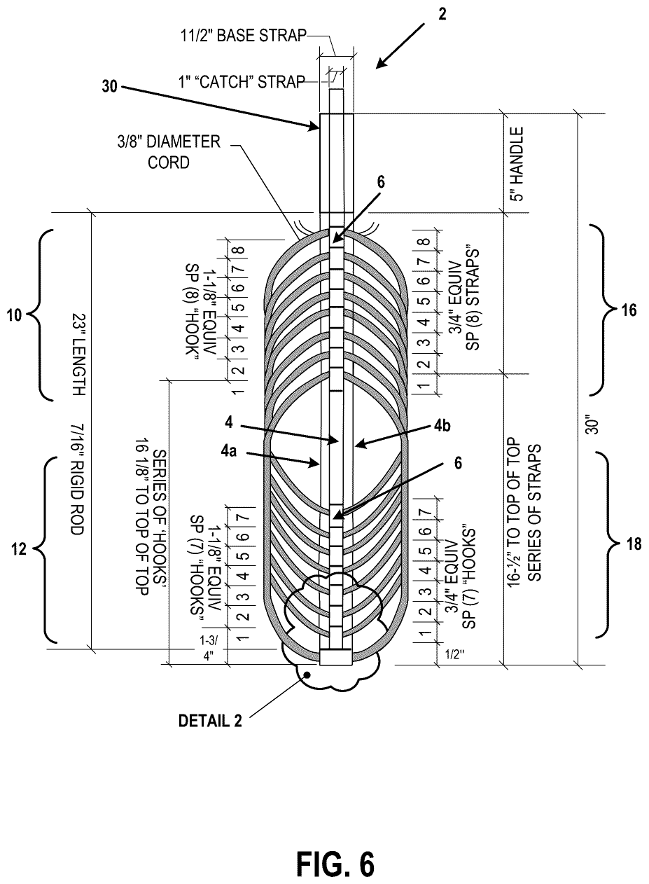

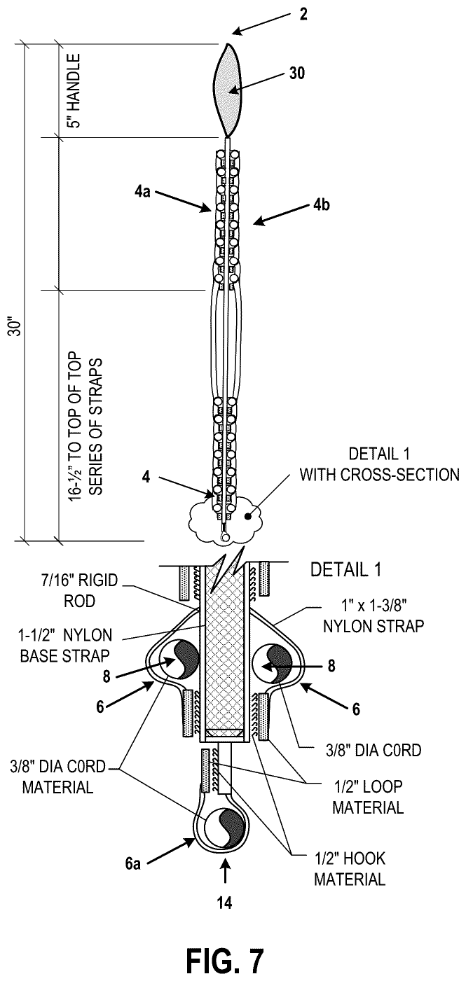

Object 8 may be stabilized and organized via apparatus 100 by first number of fasteners 10, second number of fasteners 12, or any appropriate combination thereof. An object may be secured to apparatus 100 by any appropriate number of fasteners 6. For example, an object may be secured to apparatus 100 by a single fastener 6, or by a plurality of fasteners 6. As illustrated in FIG. 1, first number of fastener 10 may be linearly (or approximately linearly) arranged on a first side of base 4 with second number of fasteners 12. Base 4 may comprise a first side 4a (visible in FIG. 1) and a second side (not visible in FIG. 1) opposite the first side. The second side of base 4 is labeled 4b in FIG. 4, FIG. 5, FIG. 6, and FIG. 7.

Apparatus 100 may comprise a handle 30. Handle 30 may be positioned at any appropriate location of apparatus 100. For example, as depicted in FIG. 1, handle 30 may be attached to base 4 at proximate end 2 of apparatus 100. Handle 30 may be attached to base 4 at distal end 14 of apparatus 100. Handle 30 may be attached to any portion between proximate end 2 and distal end 14 of base 4. Handle 30 may be attached to a central portion of base 4. Apparatus 100 may comprise multiple handles 30. For example, apparatus 100 may comprise a handle at distal end 14, at proximate end 2, a location between distal end 14 and proximate end 2, or any appropriate combination thereof. Apparatus 100 may comprise a handle central to base 4. Handle 30 may comprise any appropriate material. Handle 30 may be formed in any appropriate configuration. For example, handle 30 may comprise a loop allowing a user to hang the apparatus on a hook, or the like.

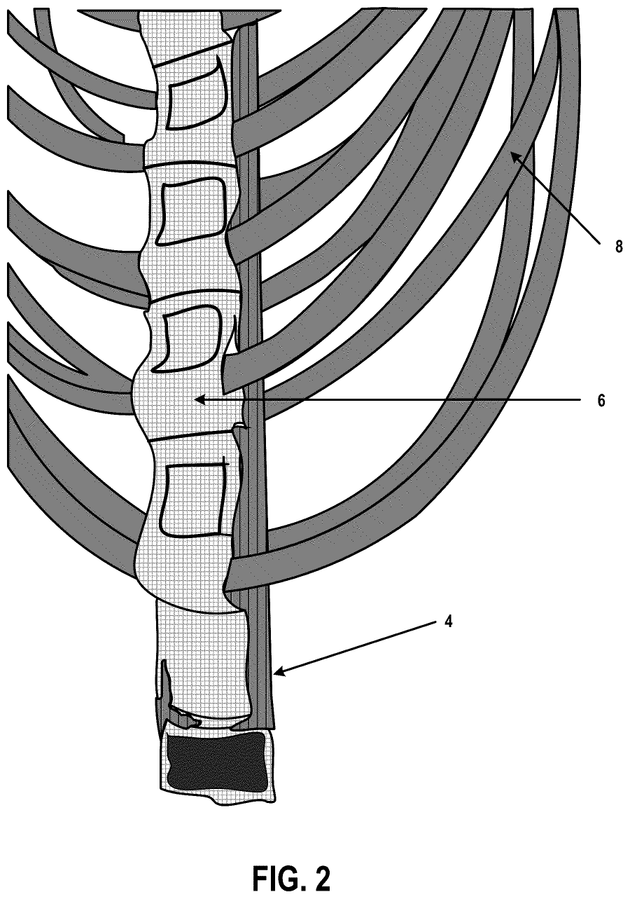

FIG. 2 depicts a more detailed illustration of a second portion of the apparatus securing and organizing the electrical cord depicted in FIG. 1. As depicted in FIG. 2, an example fastener 6 may comprise a fabric. A fastener, however, may be composed of any appropriate type of material. For example, the composition of fastener 6 may be comprise a fabric, plastic, metal, or the like, or any appropriate combination thereof. Fastener 6 may comprise any appropriate type of fastener. For example, a fastener may comprise a hook and loop type fastener, a buckle type fastener, a quick release buckle, a lever-type buckle, a lock, a pin, an adhesive, a staple, tape, a hook, a button, or the like, or any appropriate combination thereof.

Fastener 6 may be attached to base 4 by any appropriate means. For example, fastener 6 may be stitched to base 4, adhesively attached to base 4, stapled to base 4, integral to base 4, or the like, or any appropriate combination thereof. Fastener 6 may be permanently attached to base 4. Fastener 6 may be removably attached to base 4. Different fasteners 6 may be permanently attached and removably attached to base 4. That is, some fasteners 6 of a total number of fasteners 6 attached to base 4 may be permanently attached to base 4 while other fasteners 6 of the total number of fasteners 6 may be removably attached to base 4.

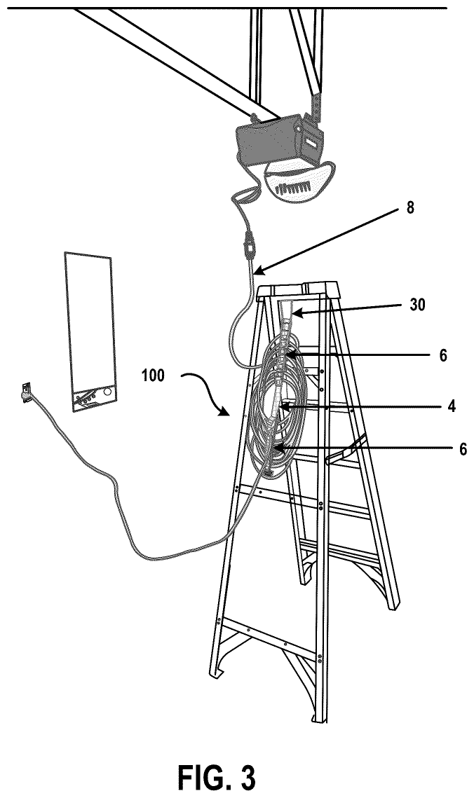

FIG. 3 depicts an example configuration of apparatus 100 in a workplace environment. As shown in FIG. 3, apparatus 100 may be attached to an appliance such as a ladder, for example, via handle 30. Apparatus 100 may be attached to any appropriate item, such as, for example, a ladder, a wall, a vehicle (e.g., truck, car, forklift, golf cart, boat, etc.). Apparatus 100 may be utilized without being attached to any item (e.g., placed on the floor).

As shown in FIG. 3, apparatus 100 may be configured to allow a portion of object 8 to be detached from apparatus 100, while a remainder of object 8 remains attached to apparatus 100. Thus, apparatus 100 provides selectable utilization of object 8. This may be advantageous when stowing away object 8, because only the portion of object 8 that was selectively utilized requires stowing.

FIG. 4 is an example illustration of a side and front view of apparatus 100. As shown in FIG. 4, base 4 may comprise first side 4a and second side 4b. First side 4a may be opposite second side 4b. Apparatus 100 may comprise a first number of fasteners 10 attached to first side 4a of base 4. First number of fasteners 10 may be positioned at proximate end 2 of apparatus 100. Apparatus 100 may comprise a second number of fasteners 12 attached to first side 4a of base 4. Second number of fasteners 12 may be positioned at distal end 14 of apparatus 100.

Apparatus 100 may comprise a third number of fasteners 16 attached to second side 4b of base 4. Third number of fasteners 16 may be positioned at proximate end 2 of apparatus 100. Apparatus 100 may comprise a fourth number of fasteners 18 attached to second side 4b of base 4. Fourth number of fasteners 18 may be positioned at distal end 14 of apparatus 100. A number of fasteners may comprise any appropriate number of fasteners, such as, for example, a single fastener or a plurality of fasteners. As depicted in FIG. 4, handle 30 may comprise a loop. The looped configuration of handle 30 may facilitate hanging or stabilizing apparatus 100 during use and for storing apparatus 100 when not in use. FIG. 4 (bottom of FIG. 4) depicts a detailed side view 20 of fastener 6 clasping object 8 and also depicting terminal fastener 6a.

FIG. 5 is a more detailed example illustration of a side and front view of apparatus 100. Base 4 may be configured in any appropriate shape or size, and may comprise any appropriate composition. For example, base 4 may comprise a 1½″×29″ nylon strap. Fastener 6 may be any appropriate shape and size, and may comprise any appropriate composition. For example, fastener 6 may comprise 1⅜ long×1″ side nylon straps. Fasteners 6 may be attached to base 4 in any appropriate manner and configuration. For example, fasteners 6 may be attached to base 4 at ¾″ increments. In an example configuration, the ½″ “loop” material of a fastener 6 (labeled 6a in FIG. 5 and referred to as a terminal fastener with reference to FIG. 7) may be attached to the bottom (distal end 14) of the 1⅜″ strap of base 4, approximately ⅛″ from the bottom (distal end 14).

In an example configuration, starting at approximately 1¾″ from the bottom (distal end 14) of base 4, a series of (e.g., 7) fasteners 6, comprising 1⅜″ straps, may be attached to base 4. Starting at approximately 1⅜″ from the distal end 14, “Hook” material of fasteners 6 may be attached at 1⅛″ increments from the bottom (distal end 14) of base 4, in, for example, a series of (7).

Starting at approximately 16½″ from the bottom (distal end 14) of the base 4, 8 fasteners 6, comprising 1⅜″ straps, may be affixed to base 4 in ¾″ increments. The “hook” material of fasteners 6 may be attached to base 4 starting at approximately 16⅛″ from the bottom (distal end 14) of the base to the top (proximate end 2) of base 4. “Hook” material may be permanently attached in a series of, for example, 8¾″ intervals moving towards the top (proximate end 2) of base 4.

This configuration may be repeated on an additional base, or bases, of equal length. Bases may be placed against each other with the 1⅜″ strap sides facing outward. These may comprise first side 4a and second side 4b.

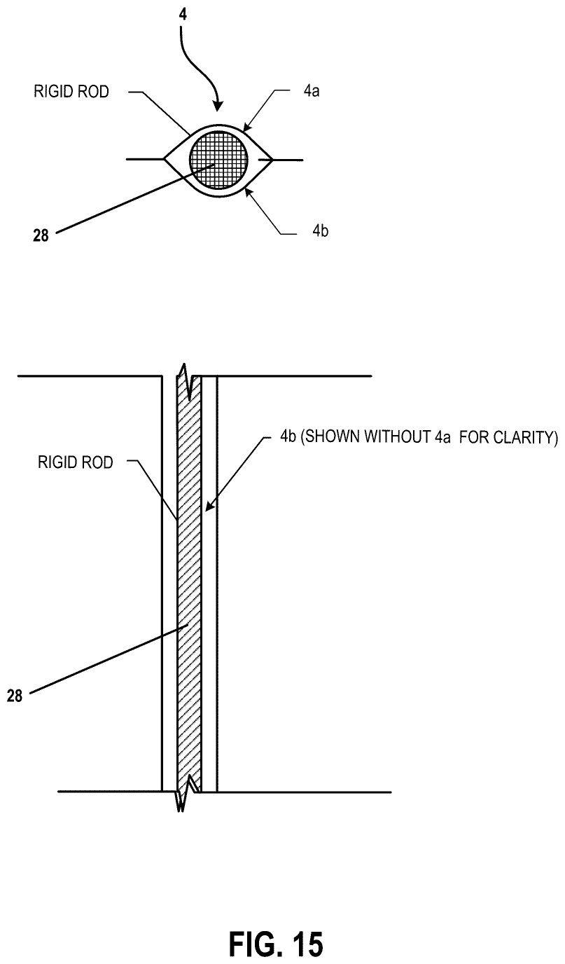

The bottom ⅝″ of base 4 may have ½″ “hook” material of fasteners 6 attached thereto. This may be permanently attached or removably attached. The bottom ⅝″ of the front 4a may comprise a nylon strap of the 1½″ base 4 strap material 2⅜″ in length. This strap may be attached to the outward facing side of the front side 4a. The bottom of the 2⅜″ strap may have ½″ of “loop” material of fastener 6 (terminal fastener 6a) attached thereto, at approximately ⅛″ from the end of the strap. This will lock with the ½″ “hook” material at the bottom end of the back strap. This is referred to at the bottom loop or mid-loop, based upon usage. Rigid support member 28, depicted in FIG. 5, is described in more detail with respect to FIG. 15.

By starting at the bottom loop or mid-loop attachment, and progressing to the first open loop on the (8) series of top straps, cord material may be fixed into a sequential loop. The cord may be wrapped downward to the lowest open (7) series of straps. This pattern may be followed for 25 linear feet of cord material. This creates sequential and equivalent loops of cord. Cord material may be dispensed and stored at desired intervals of length of cord material. For 50 linear feet of cord material, the pattern may be repeated from the middle of the cord material, starting at the mid-loop, and repeating the pattern on the back strap in the same existing pattern.

FIG. 6 and FIG. 7 illustrate detailed portions of FIG. 5. Also depicted in FIG. 7 is terminal fastener 6a located at distal end 14. Terminal fastener 6a forms a loop in which object 8 may be placed.

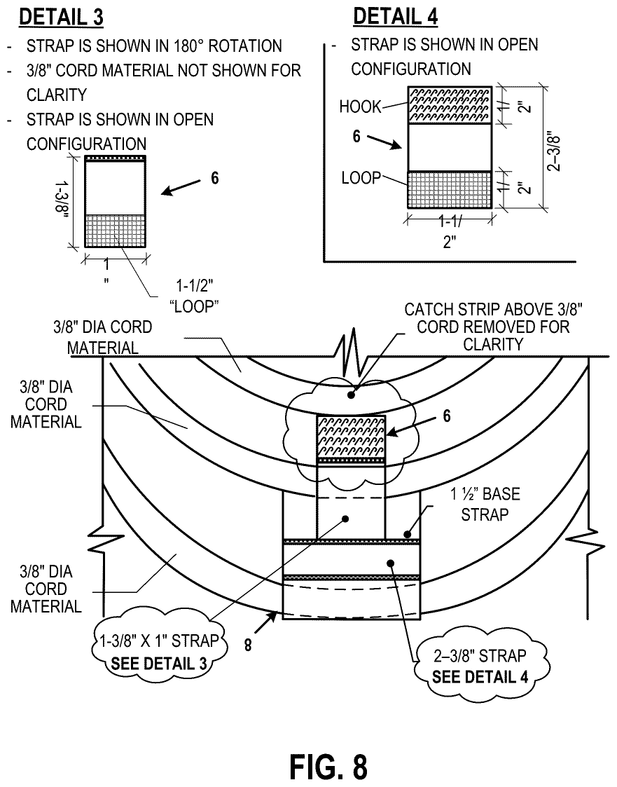

FIG. 8 is an example illustration of multiple detailed portions of the apparatus.

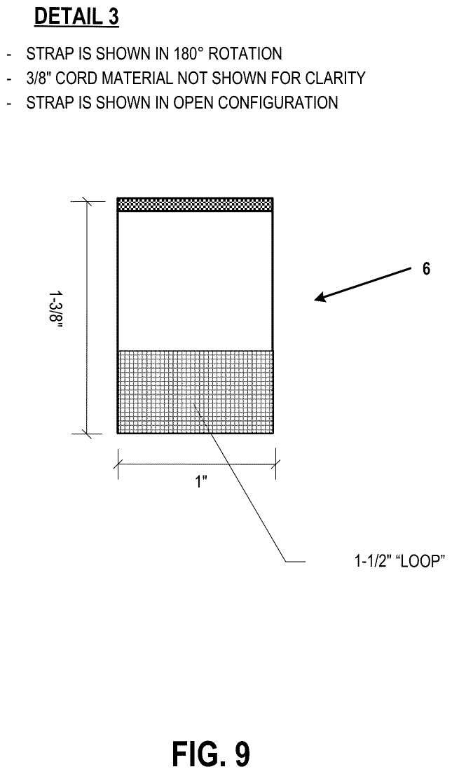

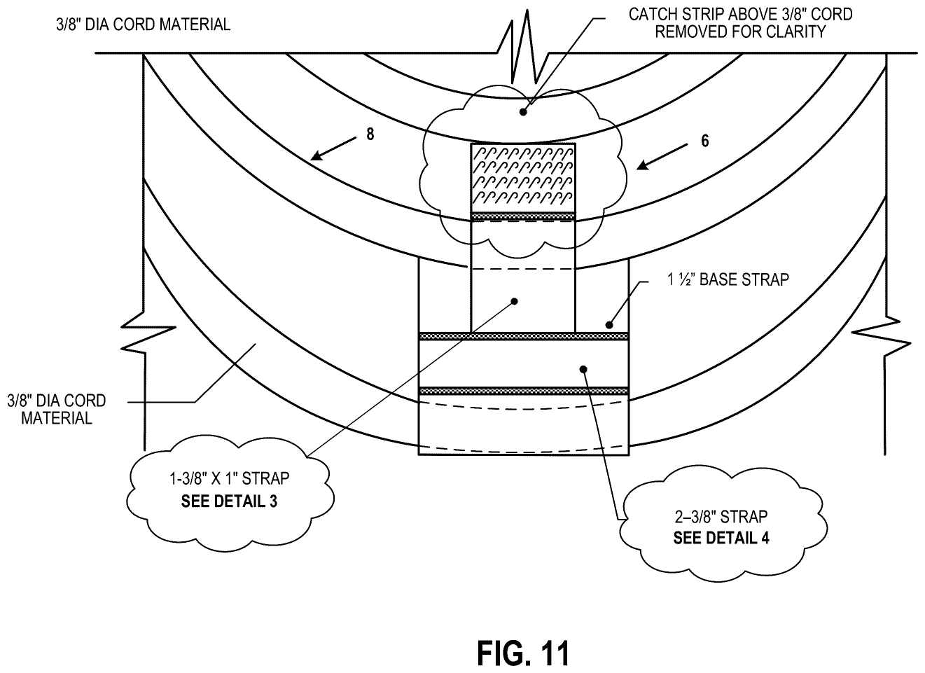

FIG. 9, FIG, 10, and FIG. 11 illustrate detailed portions of FIG. 8.

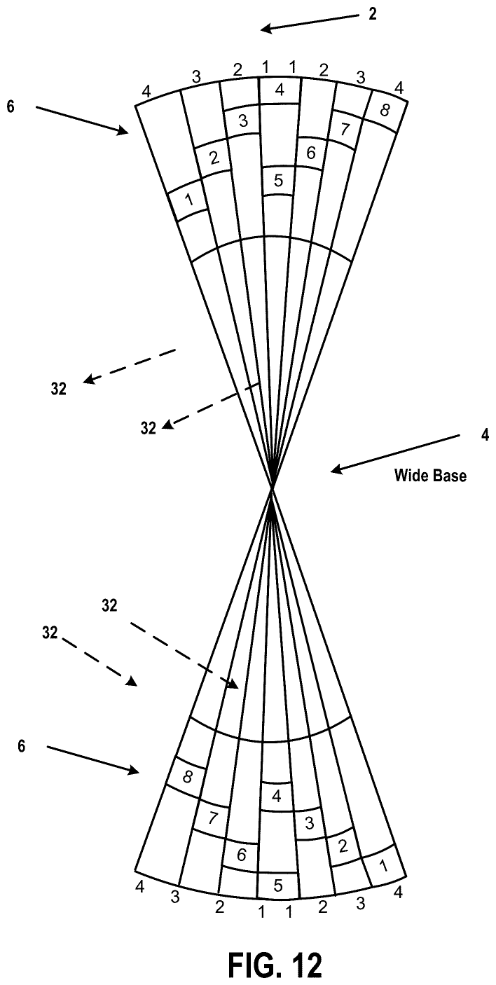

FIG. 12 is an illustration of an another example configuration of apparatus 100. As depicted in FIG. 12, the apparatus may comprise a twisted, spiral, or helix configuration. As such, fasteners 6 may be positioned in a slanted linear configuration as depicted by arrows 32. Base 4 may be configured wide enough to accommodate fasteners 6 in the spiral configuration. Base 4 may be in a cylindrical configuration. Base 4 may be in a polygon configuration, such as, for example, a rectangular configuration.

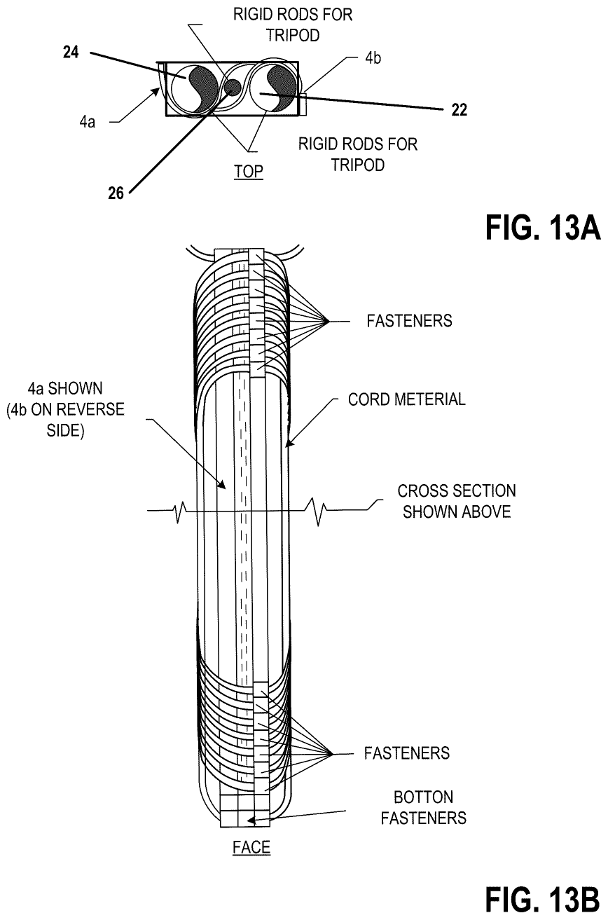

FIG. 13 is an illustration of an example tripod configuration of the apparatus.

FIG. 13A depicts a cross section view of the apparatus in an example tripod configuration. The tripod configuration of the apparatus may comprise three rigid members 22, 24, 26. FIG. 13B depicts an example tripod configuration of the apparatus in a closed configuration.

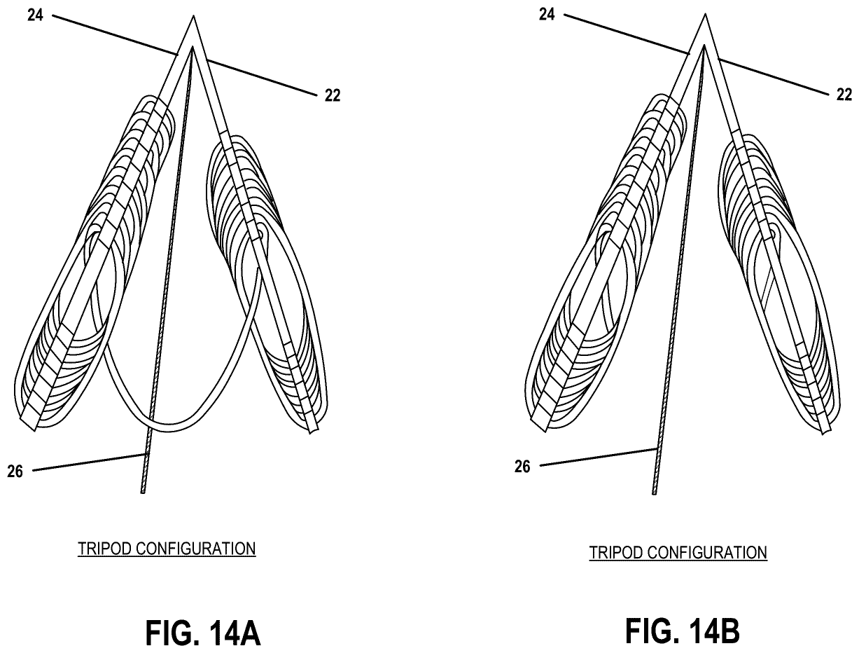

FIG. 14 depicts an example tripod configuration of the apparatus in an open configuration. As depicted, the rigid members 22, 24, 26 may be separated to provide support for the apparatus. In the open configuration, the tripod configuration of the apparatus may be free standing. As depicted in FIG. 14A, a single object is shown attached to the apparatus as an example. In various configurations, multiple objects may be attached. For example, as depicted in FIG. 14B, two objects are shown attached to the apparatus.

FIG. 15 is an example illustration of a cross section of the apparatus comprising a support member. Support member 28 may be rigid or semi-rigid. Support member 28 may comprise any appropriate material, such as, for example, wood, metal, plastic, a composite, or any appropriate combination thereof. Support may be positioned within base 4 between first side 4a and second side 4b. As described above, base 4 may be flexible. However, when configured with support member 28, base 4 may be rigid or semi-rigid, and may facilitate ease of use of the apparatus. In an example configuration, base 4 may be configured to allow insertion and removal of support member 28. In another example configuration, base 4 may be configured, such that support member is not removable. In an example configuration, support member 28 may comprise a 7/16″ diameter rigid rod attached between side 4a and side 4b of base 4 to ensure spacing of the straps.

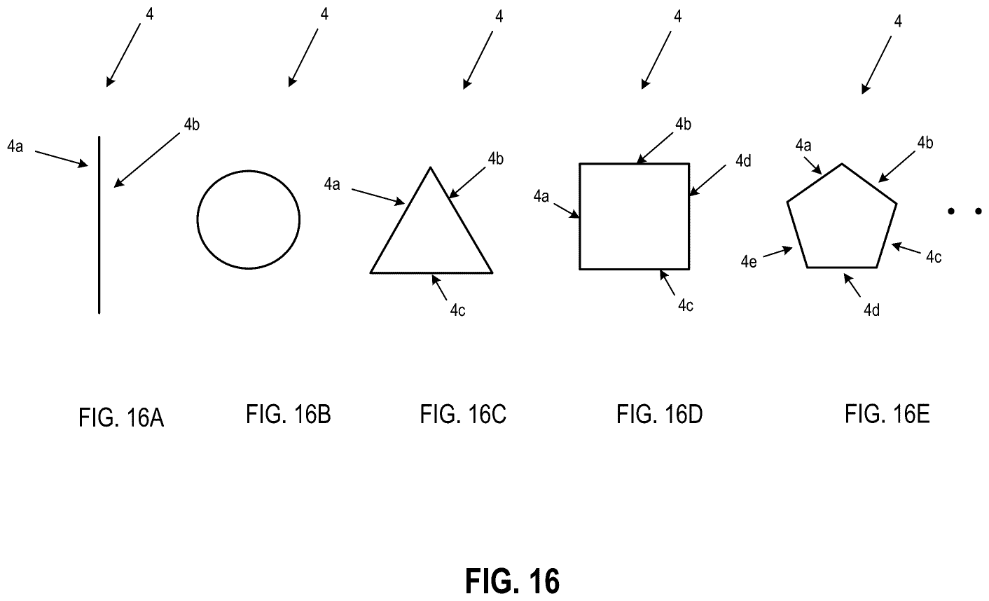

FIG. 16 illustrates cross-sectional views of various example configurations of base 4 of apparatus 100. Base 4 of apparatus 100 may comprise any appropriate number of sides. Five example configurations are illustrated in FIG. 16. FIG. 16A depicts an example two-sided configuration of base 4 comprising sides 4a and 4b. FIG. 16B depicts an example cylindrical configuration of base 4. FIG. 16C depicts an example three-sided configuration of base 4 comprising sides 4a, 4b, and 4c. FIG. 16D depicts an example four-sided configuration of base 4 comprising sides 4a, 4b, 4c, and 4d. FIG. 16E depicts an example five-sided configuration of base 4 comprising sides 4a, 4b, 4c, 4d, and 4e.

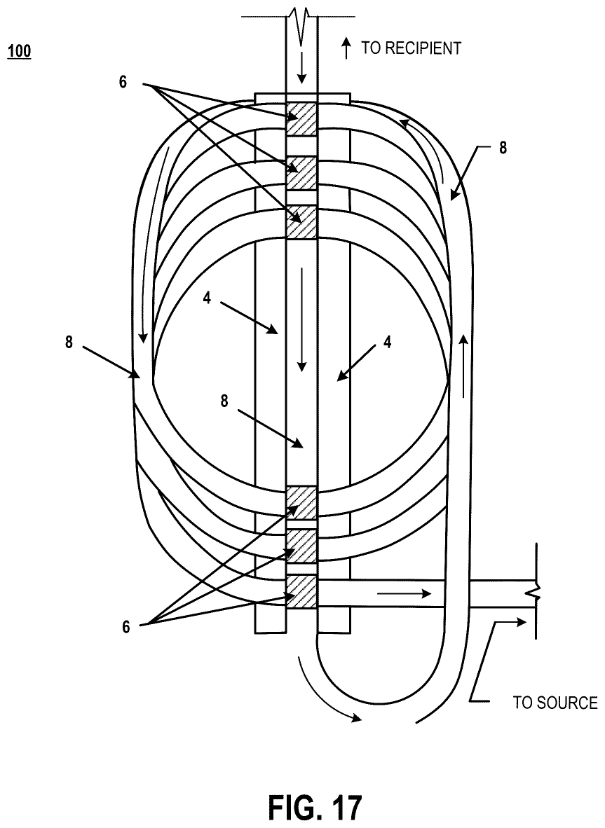

FIG. 17 illustrates a front view of an example appliance configuration of apparatus 100. In the appliance configuration depicted in FIG. 17, apparatus 100 may be utilized in conjunction with an appliance. An appliance is not illustrated in FIG. 17. An appliance may comprise any appropriate appliance that may be connected to object 8 of apparatus 100. For example, when the object 8 comprises an electrical cord, the appliance may comprise any appropriate entity that uses electricity. When the object 8 comprises a hose, conduit, or the like, that carries a fluid or gas, the appliance may comprise any appropriate entity that uses the fluid or gas (e.g., watering system, hydraulic system, pneumatic system, pressure washer, etc.). When the object 8 comprises an optical cable, the appliance may comprise any appropriate entity that uses optics (e.g., fiber optic system, computer, streaming device, set top box, router, Wi-Fi device, etc.). An example appliance may comprise a household appliance, a commercial appliance, a direct current (DC) source, an alternating current (AC) source, a computer, a generator, HVAC equipment, a heat pump, construction equipment, an electric vehicle charging station, an electric vehicle, an air dispenser system for tires, a vehicle comprising a tire (e.g., car, bicycle, etc.), a kitchen appliance, a refrigerator, an oven, a stove, an exhaust vent, a dishwasher, a trash compactor, a toaster, a toaster oven, a microwave oven, a television, a radio, a streaming device, a heater, a fire place, an electric blanket, a computer, a monitor, a watering system, a hydraulic system, a pneumatic system, a pressure washer, a fiber optic system, a streaming device, a set top box, a router, a Wi-Fi device, or the like.

As shown in the lower right corner of FIG. 17, one end of object 8 may be connected to a source. A source is not illustrated in FIG. 17. As shown at the top of FIG. 17, one end of object 8 may be connected to a recipient of what is being provided via object 8. A recipient is not illustrated in FIG. 17. A source may comprise any appropriate source such as, for example but not limited to, an electrical source, a fluid source, a gas source, an optical source, or the like. The source may comprise, for example but not limited to, an electrical receptacle, an electrical outlet, a battery, a low voltage source, a high voltage source, a DC source, an AC source, a universal serial bus (USB) interface, an extension cord, an optical connector, a power source of a charging station (e.g., charging station for electrical vehicles), a pressurized gas or fluid source of a pressurized gas or fluid system (e.g., pressured air dispenser at a gas station, high pressure air system for pneumatically operated equipment, pressurized fluid source of a hydraulic system, fluid/gas source for HVAC equipment, etc.), any appropriate source connected via an object 8 of another apparatus 100, or the like.

Apparatus 100 does not necessarily need to be attached to an appliance to be utilized with the appliance. However, apparatus 100 may be attached to an appliance via handle 30 (handle 30 not illustrated in FIG. 17). Base 4 of apparatus 100 may be attached to an appliance. Base 4 may be permanently attached to an appliance. Base 4 may be integral (e.g., part of) to an appliance. Base 4 may be removably attached to an appliance. Base 4 may be attached to an appliance via any appropriate means or mechanism. For example, base 4 may be attached to an appliance via a hook and loop fastener or fasteners, via double sided tape, via a staple, via a nail, via a screw, via an adhesive, or the like, or any appropriate combination thereof.

In an example configuration, an appliance may comprise an air pressure system at a gas station. Apparatus 100 may be permanently attached to the appliance via base 4. Object 8 may comprise an air hose for providing pressurized air. One end of object 8 may be connected to the source of pressurized air provided by the appliance. The other end of object 8 may be connected to a recipient, such as a tire of an automobile or a bicycle.

In an example configuration, an appliance may comprise a refrigerator. Apparatus 100 may be attached to the appliance via base 4, handle 30, or any appropriate combination thereof. Object 8 may comprise an electrical cord for providing electricity to the refrigerator. One end of object 8 may be connected to the source of electricity, such as an electrical outlet. The other end of object 8 may be connected to a plug (e.g., recipient) on the refrigerator.

In an example configuration, an appliance may comprise a charging station for an electric vehicle. Apparatus 100 may be permanently attached to the appliance via base 4. Object 8 may comprise an electrical cord for providing electricity to an electric vehicle. One end of object 8 may be connected to the source of source of electricity provided by the charging station. The other end of object 8 may be connected to an electric vehicle (e.g., recipient).

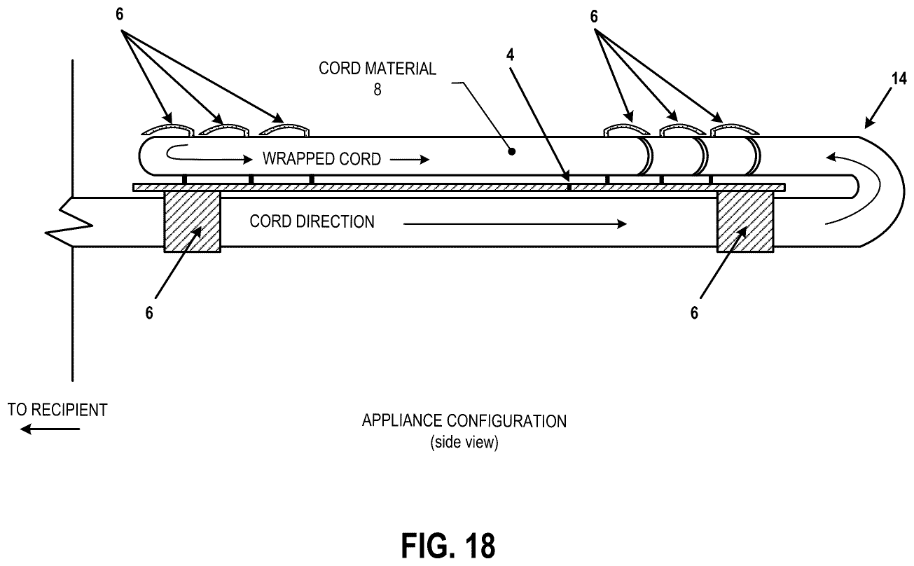

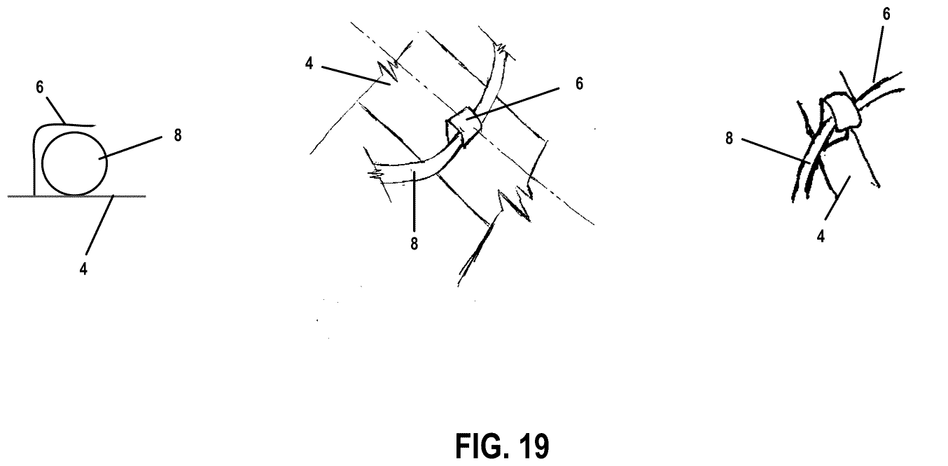

FIG. 18 illustrates a side view of an example appliance configuration of the apparatus. Fasteners 6 are configured as clasps in the example depiction of FIG. 18. FIG. 19 provides a more detailed depiction of the example clasps 6 depicted in FIG. 18. Fasteners may be rigid fasteners, compression fastener, plastic spring mechanism, hold shovel or rake organizer, rigid, but slightly flexible, permanently attached to base-not detachable like Velcro.

Features and elements are described above in particular combinations, however, one of ordinary skill in the art will appreciate that each feature or element can be used alone or in any combination with the other features and elements. This application is not to be limited in terms of the particular embodiments described in this application, which are intended as illustrations of various aspects. Many modifications and variations may be made without departing from its spirit and scope, as will be apparent to those skilled in the art. No element or act used in the description of this application should be construed as critical or essential to the invention unless explicitly provided as such. Functionally equivalent methods and apparatuses within the scope of the application, in addition to those enumerated herein, are intended to fall within the scope of the appended claims. In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. An apparatus comprising:
a base comprising a proximate end and a distal end;
a first number of fasteners positioned at the proximate end of the base;
a second number of fasteners positioned at the distal end of the base, wherein:
each fastener of the first and second number of fasteners is configured to attachably and detachably clasp an object; and
the apparatus is configured to clasp the object by fastening a coil of the object to corresponding fasteners of the first and second number of fasteners.

2. The apparatus of claim 1, further configured to clasp a plurality of coils of the object by fastening each coil of the plurality of coils to respective corresponding fasteners of the first and second number of fasteners, wherein a coil length of each coil of the plurality of coils is selectable.

3. The apparatus of claim 1, further configured to clasp a plurality of coils of the object by fastening each coil of the plurality of coils to respective corresponding fasteners of the first and second number of fasteners, wherein each coil is of approximately equal length.

4. The apparatus of claim 1, wherein the base comprises a flexible strap.

5. The apparatus of claim 1, wherein the apparatus is configured to clasp a flexible object.

6. The apparatus of claim 1, further comprising a support member within the base.

7. The apparatus of claim 6, wherein the support member is insertable and removable.

8. The apparatus of claim 1, wherein the apparatus is configured in a spiral configuration.

9. The apparatus of claim 1, wherein:
the apparatus comprises a tripod; and
when the tripod is in an open configuration, the apparatus is free standing.

10. The apparatus of claim 1, further configured to facilitate selectable utilization of the object.

11. An apparatus comprising a base and a plurality of fasteners, the base comprising a first side and a second side opposite the first side, wherein:
the first side of the base comprises:
a first proximate end and a first distal end;
a first number of fasteners positioned at the first proximate end of the first side of the base;
a second number of fasteners positioned at the first distal end of the first side of the base, wherein:
each fastener of the first and second number of fasteners on the first side of the base is configured to attachably and detachably clasp an object; and
the second side of the base comprises:
a second proximate end and a second distal end;
a third number of fasteners positioned at the second proximate end of the second side of the base;
a fourth number of fasteners positioned at the second distal end of the second of the base, wherein:
each fastener of the first, second, third, and fourth number of fasteners is configured to attachably and detachably clasp an object; and
the apparatus is configured to clasp at least one object by fastening at least one coil of the at least one object to fasteners of the apparatus.

12. The apparatus of claims 11, wherein the apparatus is configured to clasp a single object by fastening a portion of the single object to fasteners on the first side of the base and another portion of the single object to fasteners on the second side of the base.

13. The apparatus of claims 11, wherein the apparatus is configured to clasp a plurality of objects by fastening a subset of the plurality of objects to fasteners on the first side of the base and a remaining subset of the plurality of objects to fasteners on the second side of the base.

14. The apparatus of claim 11, further configured to clasp a plurality of coils of the at least one object by fastening each coil of the plurality of coils to at least one of respective corresponding fasteners of the first and second number of fasteners, respective corresponding fasteners of the third and fourth number of fasteners wherein a coil length of each coil of the plurality of coils is selectable.

15. The apparatus of claim 11, further configured to clasp a plurality of coils of the at least one object by fastening each coil of the plurality of coils to at least one of respective corresponding fasteners of the first and second number of fasteners, or respective corresponding fasteners of the third and fourth number of fasteners, wherein a coil length of each coil of the plurality of approximately equal length.

16. The apparatus of claim 11, wherein the base comprises a flexible strap.

17. The apparatus of claim 11, the apparatus configured to clasp a flexible object.

18. The apparatus of claim 11, further comprising a support member within the base.

19. The apparatus of claim 18, wherein the support member is insertable and removable.

20. The apparatus of claim 11, further configured to facilitate selectable utilization of the object.
